(19) United States
(12) Patent Application Publication
(10) Pub. No.: US 2005/0132270 A1
(43) Pub. Date: Jun. 16, 2005

(54) Method, system, and computer program product for automatic code generation in an object oriented environment

(75) Inventor: Keith J. Purcell, Willow Spring, NC (US)

Correspondence Address: SYNNESTVEDT & LECHNER, LLP, 2600 ARAMARK TOWER, 1101 MARKET STREET, PHILADELPHIA, PA, 191072950, US

(73) Assignee: International Business Machines Corporation, Armonk, NY (US)

(21) Appl. No.: 10/733,037

(22) Filed: Dec. 11, 2003

(51) Int. Cl. G06F 17/00

(52) U.S. Cl. 715/513

(57) ABSTRACT

A method, system, and computer program product for automatically developing objects using a plurality of context derived models residing within a computational grid. An object meta language (OML) is used to allow a programmer to define an application. Using OML, the programmer creates a document describing the required object. The OML document is submitted to a group of context derived models residing at various computational nodes on the grid. A web service is used to parse the OML document and select the appropriate node. The OML document is provided to the selected node, which applies object description variables using a transform language. The defined object is then returned to the programmer.

### FIELD OF THE INVENTION

The present invention relates generally to object oriented computer programming, and, more specifically, to a method, system, and computer program product for generating objects from a meta language using grid technologies.

### BACKGROUND

Object oriented programming has become the preferred technique used for drafting high level computer programs. Object oriented programming allows the programmer to develop objects and relationships between objects, thus allowing the programmer to maintain a high level of abstraction in creating applications.

While object oriented programming has several advantages, it can be a difficult and time consuming process for programmers to develop complex object oriented applications. The programmer must first determine the parameters of the application desired (e.g., input variable, desired screen appearance, output variables, etc). An appropriate format or language is then selected to create the application (e.g., gif, Java, J2EE, C/C++, etc.). Then the programmer must draft the programming code using the desired format in order to create the application or desired objects. This can be a time intensive, detailed process.

In order to simplify object oriented programming, the eXtensible Markup Language (XML) has been developed. XML is easily configurable and creates a mechanism to translate data into various other programming technologies. Because of the broad uses of XML, however, significant coding is required to develop applications directly using XML technologies.

Programming models have been developed using XML technologies in an effort to assist programmers in developing object oriented programs. Programming models include XML templates and eXtensible Style Language (XSL) models. XSL models transform XML documents into stylized versions of the original document. While an XSL style sheet can be developed to assist in creating a specific application, significant programming resources are necessary to develop a particular model for a particular application.

### SUMMARY OF THE INVENTION

The present invention provides a method, system, and computer program product for automatically developing objects using a plurality of context derived models (e.g., XML, .gif, Java, C/C++) residing within a computational grid. An object meta language (OML) is used to allow a programmer to define an application. Using OML, the programmer creates a document describing the required object. The OML document is submitted to a group of context derived models residing at various computational nodes on the grid. A web service is used to parse the OML document and select the appropriate node. The OML document is provided to the selected node, which applies object description variables using a transform language, such as eXtensible Style Language (XSL). The defined object is then returned to the programmer, thus eliminating the need for the programmer to generate the actual code for the desired object.

In an exemplary embodiment, the method for automatically developing an object comprises: creating an OML document describing the desired object in XML format; submitting the XML description to a web service; parsing the XML document by the web service to identify a node within a computational grid for generating the desired object; providing the XML document to the identified node; performing an XSL transform at the grid node; and returning the developed object via the web service.

### BRIEF DESCRIPTION OF DRAWINGS

FIG. 1 illustrates an exemplary embodiment in which the present invention operates; and

FIG. 2 is a flow chart of the steps involved in an exemplary embodiment of the present invention.

### DETAILED DESCRIPTION

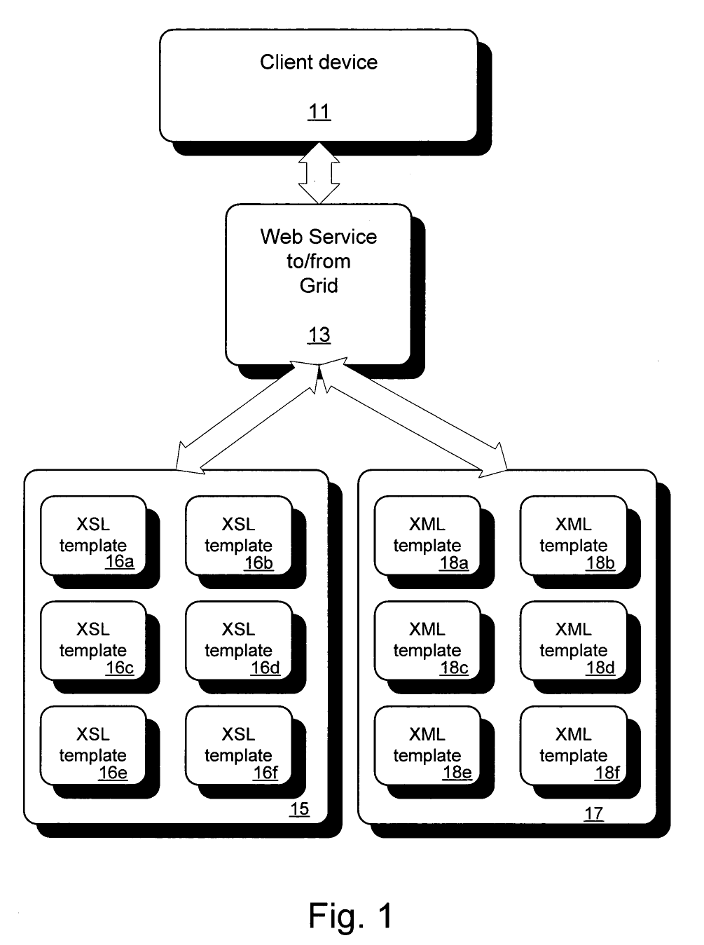

FIG. 1 illustrates an exemplary environment in which the present invention can operate. The various components of the present invention can be located on a single computer, or alternatively one or more components can reside on one or more remote computers. A programmer uses a client device 11 to interface with a network environment. The client device 11 allows the programmer to manually enter information into the system.

The client device 11 accesses one or more computational grids 15, 17 via a web service application 13, such as WebSphere® by IBM (Aromonk, N.Y.). Web service applications provide, in a well known manner, means for integrating web-based applications over the Internet. While WebSphere® is used in the exemplary implementation, the invention can be practiced using other web service applications. The web service application 13 allows the client device 1 1 to be integrated to one or more computational grids 15, 17.

Each computational grid 15, 17 comprises a series of nodes 16a, 16b, 16c, 16d, 16e, 16f, 18a, 18b, 18c, 18d, 18e, 18f. Each node contains one or more programming models. In the exemplary implementation, the programming models comprise XML templates (16a-18f) and XSL style sheets (18a-18f). Models constructed using other formats could also be used.

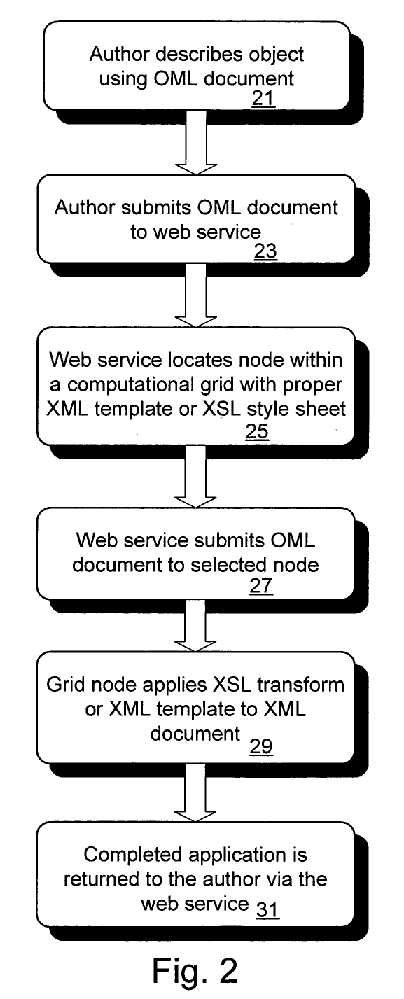

FIG. 2 is a flow chart illustrating an example of steps performed in accordance with the method of the present invention. At step 21, a programmer who desires to create an application describes the desired application in a highly abstract form. In an exemplary embodiment, an meta language is used to allow the programmer to build a description with a high level of abstractions. In an exemplary embodiment, the object meta language (OML) is an XML dialect containing meta tags that can be parsed using XML technologies. Other languages, however, could also be used to set forth the initial object definition.

The OML application definition comprises an XML template that sets forth the parameters of the application desired. In an exemplary embodiment, the programmer uses a client device to create a description of desired application by creating an OML document using XML tags and a simple text editor. All of the parameters that the author desires (e.g., text field names, desired inputs, etc.) are set forth using XML tags.

At step 23, the OML document is provided to a web service. The web service parses the document using XML technologies to determine a suitable code generation module. At step 25, the web service surveys all available grid nodes in order to locate an available node that comprises a style sheet or XML template in accordance with the application parameters set forth in the OML document. In an exemplary embodiment, the grid nodes contain XSL style sheets or XML templates capable of generating completely coded applications from XML definitions. Alternatively, the nodes could contain simple gif generation modules or more complex applications such as Java applications, J 2EE applications, or C/C++ applications. The web service selects the appropriate module based upon the OML definitions set forth by the author.

Once a suitable style sheet or template is located, the web service provides the parsed OML definition to the selected node (step 27). The node on the grid uses a context derived model to generated the code for the desired application. For example, a particular node may contain an XSL style sheet to perform an XSL/XML transform. An XML/XSL transform is used to take XML application definitions and create a fully described application by applying a predetermined style template to the parsed XML code. For example, an author might express a desire for the application to display a title by using an XML <title> tag. The XSL module takes this information and creates a styled title definition (e.g., a particular bold faced font, a shaped word configuration, a word/motion combination). The models residing on the various nodes within the grid are able to create various output formats, depending upon the application desired. For example, after the OML definition is parsed by the node and the and XML/XSL transform is applied, the output from the XML/XSL transform can be an XML document, a Java Server Page (JSP), a Java application, etc.

Once the grid node has created the application using the model, the newly created application is returned to the programmer via the web service (step 31). The programmer can then review the created application to determine if it is as desired. If the results are not as desired, the application can be edited, or alternatively, the programmer can edit the original OML definition sheet and resubmit to the web service for the process to be repeated.

To clearly explain the manner in which the present invention operates, an example of an author's OML application definition is shown below as Example #1:

### EXAMPLE #1

```
1 <?XML version=”1.0” encoding =”UTF-8?>
2 <!DOCTYPE oml-def PUBLIC “-//IBM//OML DTD
1.0//EN” “oml _1.0.dtd”>
3 <object_context com=”IBM” prer=”IBM WPS 4.1.4”>
      .
      .
      .
4 <oml-title>The process box example</oml-title>
5 <oml-subobject graphic=button gstyle_title=”Start”
action_object=URLGet>
      .
  More object description OML
      .
      .
6 </object_context
```

Using this simple XML format application description, the author creates a request for the object sought. Line 1 of example #1 sets forth the XML version and type of character encoding used in the OML definition. The use of OML is defined using the DOCTYPE command in line 2. This definition also sets forth the use of English within the document.

Line 3 indicates the required prerequisite(s) in order to process the OML document. In example #1, IBM WebSphere Portal Server 4.1.4 is required. This program will act as the web service to perform the parsing and node selection functions required in order to generate the desired object.

The desired object is given a title in the <oml-title> line (line 4 of example #1). In the above example, the desired object is entitled “The process box example.” Following the title definition, the author sets out the desired attributes of the object sought. For example, the author can request a graphic start button that performs the action URLGet when selected by the user (line 5 of the example #1). All of the desired object characteristics are set forth in this manner by the author. In this way, a complete OML definition of the desired application is built.

The OML definition is a very high level description of an application in comparison to the complete coding approach that was required in the prior art. The OML document is supplied to a web service that will parse the document and determine the best available model from all models residing within the grid or grids serviced by the web service for creating a complete application in accordance with the OML definition. In the example set forth, IBM WebSphere Portal Server 4.1.4 is the selected web service.

In the exemplary implementation, the models residing within the grid comprise XML templates and XSL style sheets. An example of an XSL style sheet that could be chosen to create the application defined in example #1 is shown below in example #2.

### EXAMPLE #2

1 <?XML version =”1.0”?>
2 -<XSL:stylesheet
3 -xmlns:xsl= “http://www.w3.org/1999/XSL/Transform”
4 -version=“1.0”
5 -xmlns:java=http://xml.apache.org/xslt/java
6 - exclude-results-prefixes=“java”>
7 <xsl:output method=“java” indent=”yes”/>
8 <xsl:output encoding =“ISO-8859-1” />
9 <xsl:strip-space elements=“*” />
10 -<xsl:template match=“/”>
11 <xsl:if test=”$Variable.oml.title!=”“>
12 <xsl:element name=“title”>
13 <xsl:value-of select=“$Variable.oml-title” />
14 </xsl:element>
15 </xsl:if>

The XSL document reads the OML variables set forth by the author and substitutes them into new objects via the XSL syntax. In the example #2, the model is defined as an XML version 1.0 type document that is an XSL stylesheet using XSL transformation specification level 1.0 from the w3.org 1999 specification (lines 1-4). These designated specifications are well known within the art.

The style sheet parses the OML document using Xerces java parsing from apache.org (line 5), which is a well known parsing technique. The output file is not to be parsed (line 6). The output file is defined to be a java file (line 7), and is to be encoded using ISO-8859-1 (line 8), which is a well known codepage.

The XSL stylesheet of example #2 will parse the input OML file and substitute the value of the variable set in the input document with the value of the file variables in the template. For example, the commands in the XSL stylesheet check for a match of the OML variable “title” and replace it with the XSL element for the title variable using an “if” clause (lines 10-15 of example #2). In this manner, the XSL stylesheet is used to replace the variable set from the input OML document with the variable set that is the result of the XSL/XML transform. In other words, the instructions within the XSL style sheet substitute the various variables found in the XML application definition into the styled format which is created by the template.

Once OML description has been transformed into a fully coded application using the XSL stylesheet, it is output to an output file (in the example, to a java file). This file is then returned to the programmer. In the exemplary embodiment, the file is returned via the web service (e.g., WebSpere Portal Server 4.1.4).

The above-described steps can be implemented using standard well-known programming techniques. The novelty of the above-described embodiment lies not in the specific programming techniques but in the use of the steps described to achieve the described results. Software programming code which embodies the present invention is typically stored in permanent storage of some type, such as permanent storage on a user workstation. In a client/server environment, such software programming code may be stored with storage associated with a server. The software programming code may be embodied on any of a variety of known media for use with a data processing system, such as a diskette, or hard drive, or CD-ROM. The code may be distributed on such media, or may be distributed to users from the memory or storage of one computer system over a network of some type to other computer systems for use by users of such other systems. The techniques and methods for embodying software program code on physical media and/or distributing software code via networks are well known and will not be further discussed herein.

The system in accordance with the present invention allows for programmers to develop applications without tedious coding. Virtually any type of object can be wrappered in an OML format that can then easily be parsed, understood, and modified using existing templates and style sheets. As a result, programming time and costs are reduced. Additionally, the level of programming skill required to be possessed by the author is significantly reduced. No longer must the author be proficient in all of the languages or code scripts desired. As long as the author can describe the application via OML text, the system in accordance with the present invention will develop the actual coded application. Using this method, any programming object from a simple gif file to a complex three tier J2EE application can be generated from existing data models.

The system's use of one or more computational grids allows for greater scalability than any currently existing program generation technique. The use of the grid provides access to a wide number of model types and model instances, creating an efficient method for generating object oriented code. Furthermore, the system in accordance with the present invention permits objects to be developed from several cooperating resources (e.g., graphics from one node, a .jsp file from a different node), which increases the level of applications that can be developed.

It should be understood that the foregoing is illustrative and not limiting and that obvious modifications may be made by those skilled in the art without departing from the spirit of the invention. Accordingly, the specification is intended to cover such alternatives, modifications, and equivalence as may be included within the spirit and scope of the invention as defined in the following claims.

1. A method for automatically generating computer program code comprising the steps of:
generating a description of an application;
providing said description to a web service;
parsing said description by said web service;
locating a suitable coding module on a node contained within a computational grid;
supplying said description to said node;
applying said description to said coding module to generate an output object;
returning said object.

2. The method as set forth in claim 1, wherein said suitable coding module comprises a plurality of coding modules.

3. The method as set forth in claim 2, wherein said plurality of coding modules is located on a plurality of nodes within a computational grid.

4. A method as set forth in claim 1, wherein said description is generated using Object Meta Language (OML).

5. A method as set forth in claim 4, wherein said OML is an extensible Markup Language (XML) dialect.

6. A method as set forth in claim 1, wherein said coding module is an XML template.

7. A method as set forth in claim 1, wherein said coding module is an extensible Style Language (XSL) style sheet.

8. A method as set forth in claim 7, wherein the step of applying said description to said object template further comprises the steps of:
parsing said description to locate at least one variable;
substituting said at least one variable with at least one replacement variable, wherein said at least one replacement variable is the result of an XML/XSL transform.

9. A method as set forth in claim 6, wherein the step of applying said description to said object template further comprises the steps of:
parsing said description to locate at least one variable;
substituting said at least one variable with at least one replacement variable, wherein said at least one replacement variable is stored in said XML template.

10. A method as set forth in claim 1, wherein said web service is IBM WebSphere.

11. A method as set forth in claim 1, wherein said output object is a java file.

12. A computer program product for automatically generating computer program code, comprising computer executable instructions for:
generating a description of an application;
providing said description to a web service;
parsing said description by said web service;
locating a suitable object template on a node contained within a computational grid;
supplying said description to said node;
applying said description to said object template;
returning object.

13. The computer program product as set forth in claim 12, wherein said description comprises Object Meta Language (OML).

14. The computer program product as set forth in claim 12 wherein said OML is an eXtensible Markup Language (XML) dialect.

15. The computer program product as set forth in claim 12 wherein said coding module is an XML template.

16. The computer program product as set forth in claim 12 wherein said coding module is an eXtensible Style Language (XSL) style sheet.

17. The computer programming product as set forth in claim 15 wherein the computer readable instructions for applying said description to said object template further comprise instructions for:
parsing said description to locate at least one variable;
substituting said at least one variable with at least one replacement variable, wherein said at least one replacement variable is the result of an XML/XSL transform.

18. The computer programming product as set forth in claim 15 wherein the computer readable instructions for applying said description to said object template further comprise instructions for:
parsing said description to locate at least one variable;
substituting said at least one variable with at least one replacement variable, wherein said at least one replacement variable is stored in said XML template.

19. A system for automatically generating computer program code comprising:
an input terminal for inputting an application description;
a computational grid have at least one node;
a web service for supplying said application description to said node;
a coding module residing on said node, wherein said coding module generates an object from said description.

20. The system as set forth in claim 19, wherein said coding module comprises a plurality of coding modules.

21. The system as set forth in claim 19 wherein said description is generated using Object Meta Language (OML).

22. The system as set forth in claim 18 wherein said OML is an extensible Markup Language (XML) dialect.

23. The system as set forth in claim 19 wherein said coding module is an XML template.

24. The system as set forth in claim 19 wherein said coding module is an extensible Style Language (XSL) style sheet.

25. The system as set forth in claim 24 wherein said coding module for generating an object from said description includes computer code for:
parsing said description to locate at least, one variable;
substituting said at least one variable with at least one replacement variable, wherein said at least one replacement variable is the result of an XML/XSL transform.

26. The system as set forth in claim 23 wherein said coding module for generating an object from said description includes computer code for:
parsing said description to locate at least one variable;
substituting said at least one variable with at least one replacement variable, wherein said at least one replacement variable is stored in said XML template.

27. The system as set forth in claim 19 wherein said web service is IBM WebSphere.
